(19) United States
(12) Patent Application Publication
(10) Pub. No.: US 2008/0308454 A1
(43) Pub. Date: Dec. 18, 2008

(54) Basic Cracking Compositions Substantially Free Of Large Pore Zeolites

(75) Inventors: Elbert Arjan De Graaf, Amsterdam (NL); King Yen Yung, Almere (NL); Raymond Paul Fletcher, Den Haag (NL); Erja Paivi Helena Rautiainen, Leusden (NL)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., Amersfoort (NL)

(21) Appl. No.: 12/135,377

(22) Filed: Jun. 9, 2008

Related U.S. Application Data
(60) Provisional application No. 60/942,757, filed on Jun. 8, 2007.

(51) Int. Cl. C10G 11/05; B01J 29/06

(52) U.S. Cl. 208/120.01; 502/60; 502/73; 502/77; 502/64

(57) ABSTRACT

Novel catalytic compositions for cracking of crude oil fractions are disclosed. The catalytic compositions comprise a basic material and at least one intermediate and/or small pore zeolite, and comprises little to no large pore zeolite.

Crude oil is a complex mixture of hydrocarbons. In a refinery, crude oil is subjected to distillation processes to make a first separation by boiling point. One of the main fractions obtained in this process is Vacuum Gas Oil (VGO), which is commonly treated further in a cracking process, in particular a fluid catalytic cracking (FCC) process. Other feedstocks for cracking process include among others hydrotreated VGO and atmospheric resid.

Cracking is the process by which the relatively large molecules in a feedstock such as VGO are converted to lighter fractions. This may be done by heating the VGO under non-oxidizing conditions, so-called thermal tracking. If done in the presence of a catalyst, the cracking process may be carried out at a lower temperature.

A major part of catalytic cracking is presently carried out in a fluid catalytic cracking process, or FCC process. In this process, small particles of catalytic material are suspended in a lifting gas. The feedstock is sprayed onto the catalyst particles through a nozzle. The feedstock molecules are cracked on the catalyst particles. The lift gas carries products and catalyst particles through the reactor. After the reaction the catalyst particles are separated from the reaction products, and sent to a stripping section where the catalyst is subjected to a severe steam treatment to remove as much of the hydrocarbon molecules as possible. After the stripper, the catalyst particles are transferred to a regenerator where coke that was formed during the reaction is burned off, and the catalyst is regenerated for further use.

The catalyst in a standard FCC process comprises an acidic zeolite, such as Y-zeolite or a stabilized form of a Y-zeolite. Generally, the Y-zeolite is combined with a matrix material, which may be alumina or silica-alumina. The catalyst may further comprise components for improving its resistance against poisoning by metal contaminants of the feedstock, in particular nickel and vanadium. Other components may be present to capture sulfur from the feedstock. The actual cracking process takes place on the acidic sites of the zeolite.

The product of the FCC process is subsequently split into several fractions. Dry gas is a low molecular weight fraction that does not liquefy when compressed at ambient temperature (hence the term dry). The dry gas comprises hydrogen, methane, ethane and ethene. The liquefied petroleum gas (LPG) fraction consists of compounds that are in the gas form at room temperature, but liquefy when compressed. This fraction comprises predominantly propane, propene, butane, and its mono- and di-olefins.

The gasoline fraction may have a boiling point range of from about the boiling point of nC₅ (36° C.) to about 220° C. The endpoint may be varied to meet specific objectives of the refining process. The gasoline fraction forms the basis of commercial gasoline sold as a fuel for vehicles equipped with an Otto engine. One of the main requirements for the gasoline fraction is that it has as high an octane number as possible. Straight-chain hydrocarbons have a low octane number; branched-chain hydrocarbons have a higher octane number, with the octane number further increasing with the number of alkyl groups. Olefins have a high octane number, and aromatics have an even higher octane number.

The light cycle oil fraction, or LCO fraction, forms the basis for fuel oil. It is the fraction having a boiling point above that of the gasoline fraction and lower than about 340° C. Hydrotreatment is required to convert the LCO to diesel fuel.

The quality of the LCO, in terms of its nitrogen content, its sulfur content and its aromatics content, determine the rate at which the LCO fraction may be blended into the feed that will be converted to diesel fuel in the hydrotreatment process. It is important for diesel fuel to have as high a cetane number as possible. Straight-chain hydrocarbons have a high cetane number; branched-chain hydrocarbons, olefins and aromatics have low cetane numbers.

The product fraction having a boiling point above about 340° C. is referred to as “bottoms” or slurry. Although it is desirable to operate at the highest possible conversion, the composition of the product mix is adversely affected by operating at high conversion rates. For example, the coke yield increases as the conversion increases. Coke is a term describing the formation of carbon and pre-carbon deposits onto the catalyst. Up to a point, the formation of coke is essential to the cracking process as it provides the energy for the endothermic cracking reaction. A high coke yield is, however, undesirable, because it results in a loss of hydrocarbon material and disruption of the heat balance as burning off of the coke produces more heat than the process requires. Under these conditions it may be necessary to release part of the produced heat, for example by providing a catalyst-cooling device in the regenerator, or to operate the process in a partial combustion mode.

The fraction of the bottoms having a boiling point between about 340 and about 496° C. is referred to as heavy cycle oil, or HCO.

In general, the most desirable fractions of the FCC products stream are the light olefins, the gasoline fraction, and the LCO fraction. The desired split between the last two is determined by the demand for diesel and gasoline, and by the seasonal demand for heating fuel.

Because of the need for a high cetane number, it is desirable to keep the amount of aromatics in the light cycle oil fraction as low as possible. In terms of their boiling points, a large portion of any aromatics formed in FCC will end up in the light cycle oil fraction. It is therefore desirable to minimize the amount of aromatics that is formed in the cracking process.

Lighter aromatics, such as benzene and toluene, become part of the gasoline fraction of the product stream. Because of their high octane numbers, the aromatic components of gasoline might be considered desirable. However, because of a growing concern about the toxicity of aromatic compounds, it has become desirable to form a gasoline fraction that is low in aromatics content. The octane number of the gasoline pool of the refinery can be increased by alkylation of the butylenes and the isobutane streams from the FCC. Additional butane may be needed from other refinery processes. The high quality alkylate has also a desirable very low aromatics content, thereby reducing the aromatics content of the total gasoline pool.

US 2005/0121363 (Vierheilig et al.) discloses an FCC process wherein hydrotalcite-like compounds are used as an additive for reducing sulfur in gasoline. Small amounts of hydrotalcite-like compounds are used in combination with a catalyst comprising a large pore acidic zeolite, such as E-cat.

U.S. Pat. No. 3,904,550 (Pine) discloses a catalyst support comprised of alumina and aluminum phosphate. The support is used for catalysts useful in hydrodesulfurization and hydrodenitrogenation processes. The support material may also be combined with acidic zeolitic materials for use in hydrocracking or catalytic cracking.

It is desirable to develop a catalyst for use in a cracking process for the cracking of FCC feed stock whereby the formation of aromatics in the light cycle oil fraction is reduced, as compared to conventional FCC processes, without deleterious effects to the olefinic characteristics of the FCC gasoline fraction.

While not being bound by any proposed theory, the present invention is believed to be based on the discovery that a catalyst having basic sites catalyzes the cracking reaction via a radical, or one-electron, mechanism. This is the same mechanism as occurs in thermal cracking. The difference with thermal cracking is that the presence of a catalyst increases the rate of reaction, making it possible to operate at lower reaction temperatures as compared to thermal cracking. By contrast, the traditional FCC processes use an acidic material, commonly an acidic zeolite, as the cracking catalyst. The acidic sites of the catalyst catalyze the cracking reaction via a two-electron mechanism. This mechanism favors the formation of high molecular weight olefins, which readily become cyclized to form cycloalkanes. The cycloalkanes in turn readily react to aromatics via hydrogen transfer catalyzed by the large pore zeolites. The amount and properties of large pore zeolites, such as USY, REY and others known in the art, determine the extent of this reaction. Even small amounts of large pore zeolites increase the activity of the catalyst system significantly, however at the cost of LCO quality. Therefore, the amount of large pore zeolite in the catalyst blend is preferably less than 15%, more preferably less than 10% and more preferably is less than 5% zeolite. The most preferred catalyst composition is one that is substantially free of large pore zeolite.

As stated above, the catalyst in a standard FCC process comprises an acidic large pore zeolite, such as Y-zeolite or a stabilized form of a Y-zeolite. Generally, the Y-zeolite is combined with a matrix material, which may be alumina or silica-alumina. The presence of the large pore zeolite improves FCC gasoline octane by increasing aromaticity. Intermediate pore and/or small pore zeolites have been added to conventional FCC catalysts to increase production of LPG, particularly propylene. However, the effect of intermediate pore and/or small pore zeolite is limited due to the high aromatization tendency of the large pore zeolite.

When the nature of the FCC catalyst blend is basic, the quality of the FCC gasoline fraction from the reactor becomes olefinic and very unstable. These olefins may be converted into LPG by employing intermediate and/or small pore zeolite. Thus, one benefit of a basic FCC catalyst blend, reduced aromaticity, may be combined with one benefit of intermediate and/or small pore zeolite to produce an FCC gasoline fraction having acceptable olefinicity, an LCO fraction having acceptable aromaticity, and/or increased propylene production.

In addition, the bottoms fraction will also be less aromatic as compared to conventional FCC catalysts yields. Thus, the bottoms fraction can be more easily recycled to the reactor or to a higher severity FCC operation. The bottoms fraction may also be hydrotreated prior to catalytic cracking, or may be processed in a hydrocracker.

Accordingly, the present invention, in one embodiment, is a catalytic composition comprising a basic material and an intermediate and/or small pore zeolite, wherein the catalytic composition is substantially free of large pore zeolite. The term “catalytic composition” as used herein refers to the combination of catalytic materials that is contacted with an FCC feedstock in an FCC process. The catalytic composition may consist of one type of catalytic particles, or may be a combination of different types of particles. For example, the catalytic composition may comprise particles of a main catalytic material and particles of a catalyst additive. The combined composition should contain very little large pore zeolite, and is preferably substantially free of large pore zeolite.

The catalytic compositions of the present invention provide a conversion of FCC feed stock of at least 10% at a catalyst-to-oil (CTO) ratio of 10 and a riser outlet temperature below 700° C. Conversion is defined as (dry gas)+(LPG)+(Gasoline)+(Coke)=100−(Bottoms)−(LCO). Preferably the conversion is at least 20%, more preferably at least 30%.

Materials suitable for use as catalytic compositions in the present invention include basic materials (both Lewis bases and Bronstedt bases), solid materials having vacancies, transition metals, and phosphates. It is desirable that the materials have a low dehydrogenating activity and do not catalyze hydrogen transfer. Preferably, the catalytic compositions of the present invention are substantially free of components having a dehydrogenating activity. For example, it has been discovered, that compounds of several transition metals tend to have too strong a dehydrogenation activity to be useful in this context. Although they may possess the required basic character, the dehydrogenation activity of these materials results in an undesirably high coke yield and formation of too much aromatics. As a general rule, transition metals that tend to be present in or convert to their metallic state under FCC conditions have too high a dehydrogenation activity to be useful for the present purpose.

The basic material may be supported on a suitable carrier. For this purpose the basic material may be deposited on the carrier by any suitable method known in the art.

The carrier material may be acidic in nature. In many cases the basic material will cover the acidic sites of the carrier, resulting in a catalyst having the required basic character. Suitable carrier materials include the refractory oxides, in particular alumina, silica, silica-alumina, titania, zirconia, and mixtures thereof.

Suitable basic materials for use in the catalytic compositions of the present invention include compounds of alkali metals, compounds of alkaline earth metals, compounds of trivalent metals, compounds of transition metals, compounds of the Lanthanides, and mixtures thereof.

Suitable compounds include the oxides, the hydroxides and the phosphates of these elements.

A class of materials preferred as basic materials in the catalytic compositions of the present invention are mixed metal oxides, mixed metal hydroxides, and mixed metal phosphates. Cationic and anionic layered materials are suitable as precursors to mixed metal oxides.

Another group of preferred basic materials for the present invention are compounds of transition metals, in particular the oxides, hydroxides and phosphates. Preferred are compounds of transition metals that do not have a strong dehydrogenation activity. Examples of suitable materials include ZrO₂, Y₂O₃, and Nb₂O₅.

A preferred class of materials for use as basic catalytic compositions in the present invention are anionic clays, in particular hydrotalcite-like materials.

In hydrotalcite-like anionic clays, the brucite-like main layers are built up of octahedra alternating with interlayers in which water molecules and anions, more particularly carbonate ions, are distributed.

The interlayers may contain anions such as NO₃⁻, OH⁻, Cl⁻, I⁻, SO₄²⁻, SiO₃²⁻, CrO₄²⁻, BO₃²⁻, MnO₄⁻, HGaO₃²⁻, HVO₄²⁻, ClO₄⁻, BO₃³⁻, pillaring anions such as V₁₀O₂₈⁶⁻, monocarboxylates such as acetate, dicarboxylates such as oxalate, alkylsulfonates such as laurylsulfonate.

“True” hydrotalcite, that is hydrotalcites having magnesium as the divalent metal and alumina as the trivalent metal, is preferred for use in the present invention.

The catalytic selectivity of a hydrotalcite-like material (including hydrotalcite itself) may be improved by subjecting the hydrotalcite to heat deactivation. A suitable method for heat deactivating a hydrotalcite material comprises treating the material in air or steam for several hours, for example five to 20 hours, at a temperature of from 300 to 900° C. Heating causes the layered structure to collapse and amorphous material to be formed. Upon continued heating, a doped periclase structure is formed, in which some of the Mg²⁺ sites are filled with Al³⁺. In other words, vacancies are formed, which have been found to improve the selectivity of the catalytic material.

Extreme heat treatment will cause this material to segregate into a periclase and a spinel structure. The spinel structure is inactive as a catalyst. Significant spinel formation has been observed after heating a hydrotalcite material for four hours at 900° C.

Another preferred class of basic materials is the aluminum phosphates.

The activity and the selectivity of the above-mentioned materials may be adjusted by doping these materials with another metal. In general, most transition metals are suitable dopants for use in this context. Notable exceptions include those transition metals that have a dehydrogenating activity, such as nickel, and the platinum group metals. Fe and Mo have also been found to be unsuitable.

Preferred dopants include metal cations from Groups IIb, IIIb, IVb of the Periodic Table of elements, and the rare earth metals. Specifically preferred dopants include La, W, Zn, Zr, and mixtures thereof.

The catalytic compositions of the present invention may further comprise an acidic material, provided that the overall character of the catalyst remains predominantly basic. The term “predominantly basic” is used herein to mean that less than about 40% of the material's sites are acidic. This is because the overall character of the material tends to become acidic under this condition. The presence of a material having acidic sites may be desirable in terms of improving the overall activity of the catalyst.

Silica-magnesia is an example of a material having both basic and acidic sites.

Suitable predominately basic materials having acidic sites include silica sol, metal doped silica sol, and nano-scale composites of silica with other refractory oxides.

Zeolites are crystalline aluminosilicates which have a uniform crystal structure characterized by a large number of regular small cavities that can be interconnected by a large number of even smaller rectangular channels. It was discovered that, by virtue of this structure consisting of a network of interconnected uniformly sized cavities and channels, crystalline zeolites are able to accept for absorption molecules having sizes below a certain well defined value whilst rejecting molecules of larger size, and for this reason they have come to be known as “molecular sieves.” This characteristic structure also gives them catalytic properties, especially for certain types of hydrocarbon conversions.

Intermediate and smaller pore zeolites are characterized by having an effective pore opening diameter of less than or equal to 0.7 nm, rings of 10 or fewer members and a Constraint Index of less than 31 and greater than 2. Intermediate and/or small pore zeolites useful in the present invention include the ZSM family of zeolites, including but not limited to ZSM-5, ZSM-11, ZSM-12, ZSM-23, ZSM-35, ZSM-38, ZSM-48, and other similar materials. Other suitable medium or smaller pore zeolites include ferrierite, erionite, and ST-5, ITQ, and similar materials. The crystalline aluminosilicate zeolite known as ZSM-5 is particularly described in U.S. Pat. No. 3,702,886; the disclosure of which is incorporated herein by reference. ZSM-5 crystalline aluminosilicate is characterized by a silica-to-alumina mole ratio of greater than 5 and more precisely in the anhydrous state by the general formula:

[0.9±0.2M_{2/n}O:Al₂O₃:>5SiO₂]

wherein M having a valence n is selected from the group consisting of a mixture of alkali metal cations and organo ammonium cations, particularly a mixture of sodium and tetraalkyl ammonium cations, the alkyl groups of which preferably contain 2 to 5 carbon atoms. The term “anhydrous” as used in the above context means that molecular water is not included in the formula. In general, the mole ratio of SiO₂ to Al₂O₃ for a ZSM-5 zeolite can vary widely. For example, ZSM-5 zeolites can be aluminum-free in which the ZSM-5 is formed from an alkali mixture of silica containing only impurities of aluminum. All zeolites characterized as ZSM-5, however, will have the characteristic X-ray diffraction pattern set forth in U.S. Pat. No. 3,702,886, regardless of the aluminum content of the zeolite.

Any known process may be employed to produce the intermediate and/or small pore zeolites useful in the present invention. Crystalline aluminosilicates in general have been prepared from mixtures of oxides including sodium oxide, alumina, silica and water. More recently clays and coprecipitated aluminosilicate gels, in the dehydrated form, have been used as sources of alumina and silica in reaction systems.

A suitable method for preparing a catalyst having a high attrition resistance is described in U.S. Pat. No. 6,589,902 to Stamires et al., the disclosures of which are incorporated herein by reference.

The catalytic compositions of the present invention should contain between about 1 to about 75 wt % of at least one intermediate and/or small pore zeolite with greater than about 5 wt % being preferred, greater than about 10% being more preferred. The catalytic composition preferably comprises two distinct particles: one comprising a basic material and the other comprising the intermediate and/or small pore zeolite.

The catalytic compositions of the present invention preferably have a relatively high specific surface area, to compensate for their activity being lower than that of conventional FCC catalysts. Preferably the catalytic compositions have a specific surface area as measured by the BET method after steam deactivation at 600° C. for 2 hours of at least 60 m²/g, preferably at least 90 m²/g.

Another aspect of the present invention is an FCC process comprising the step of contacting an FCC feed stock with the catalytic composition of the present invention under FCC reaction conditions. The FCC feed stock may be VGO, hydrotreated VGO, atmospheric resid, and mixtures thereof. The term “FCC process” as used herein refers to process conditions that are typical for conventional FCC processes. Specifically, the temperature at the riser exit is less than about 600° C., preferably less than 550° C.; the total pressure is less than 2 bar, with the hydrogen partial pressure being even less than the total pressure. The conversion is typically less than 70%.

It will be understood that the term FCC process does not encompass hydrotreatment processes, which require elevated hydrogen pressures on the order of 100 bar or more. The term FCC process also does not encompass steam pyrolysis, which is carried out at temperatures above 600° C., and results in a conversion of more than 90%, typically (close to) 100%.

### EXAMPLE

Hydrotalcite was prepared following the procedure described in U.S. Pat. No. 6,589,902. The Mg to Al ratio was 4:1. The hydrotalcite was calcined at 600° C. for one hour.

The catalytic activity and selectivity of the hydrotalcite and a blend of 60 wt % hydrotalcite and 40 wt % ZSM-5 was evaluated in a micro-activity reactor. VGO was used as feedstock. All test reactions were performed at a contact temperature of 550° C.

Characteristics of VGO

| a) Simdist ° C. | |
|---|---|
| 5 wt % | 345 |
| 10 wt % | 365 |
| 20 wt % | 391 |
| 30 wt % | 409 |
| 40 wt % | 425 |
| 50 wt % | 445 |
| 60 wt % | 462 |
| 70 wt % | 488 |
| 80 wt % | 515 |
| 90 wt % | 548 |
| 95 wt % | 570 |
| b) Saturates, wt % | 63.7 |
| c) Mono-Aromatics, wt % | 16.3 |
| d) Di − Aromatics, wt % | 10.5 |
| e) Di + Aromatics/Polars, wt % | 9.5 |
| f) Sulfur, ppmwt | 6400 |
| g) Nitrogen, ppmwt | 1170 |
| h) CCR, wt % | 0.4 |

The reaction product was subjected to distillation. The light cycle oil fraction (LCO fraction) was separated and analyzed for total aromatics content using calibrated gas chromatography. The coke yield was determined by analyzing the CO and CO₂ contents of the effluent of the regenerator under oxidizing conditions.

The table below illustrates that the addition of ZSM-5 decreases coke, gasoline and LCO yields, at the expense of bottoms yield. The increase in LPG yield is significant (136%), as is the change in dry gas composition. Yields are expressed as wt % of feed. In addition, the presence of the ZSM-5 only has a minor influence on the aromaticity of the LCO, contrary to blending large pore zeolites, such as in conventional FCC catalyst compositions. LCO composition is expressed as wt % of LCO fraction.

| | Hydrotalcite | Hydrotalcite + ZSM-5 | Delta |
|---|---|---|---|
| Coke | 11.0 | 5.2 | −5.7 |
| Dry Gas | 4.7 | 5.1 | 0.5 |
| LPG | 8.5 | 20.1 | 11.5 |
| Gasoline | 19.6 | 12.4 | −7.2 |
| LCO | 27.3 | 21.0 | −6.3 |
| Bottoms | 28.5 | 35.8 | 7.4 |
| LCO saturates | 40.7 | 37.2 | −3.5 |
| LCO n-paraffins | 10.7 | 4.0 | −6.7 |
| LCO isoparaffins | 8.1 | 9.1 | 1.0 |
| LCO naphthenes | 21.9 | 24.2 | 2.3 |
| LCO olefins | 20.0 | 16.2 | −3.8 |
| LCO aromatics | 39.3 | 46.5 | 7.2 |

1. An FCC catalytic composition comprising a predominantly basic material and at least one intermediate or small pore zeolite, wherein the catalytic composition comprises less than 15 wt % large pore zeolite.

2. The catalytic composition of claim 1, wherein the catalytic composition comprises less than 10 wt % large pore zeolite.

3. The catalytic composition of claim 1, wherein the catalytic composition comprises less than 5 wt % large pore zeolite.

4. The catalytic composition of claim 1, wherein the catalytic composition is substantially free of large pore zeolite.

5. The catalytic composition of claim 1, wherein the basic material is substantially free of components having a dehydrogenating activity or hydrogen transfer activity.

6. The catalytic composition of claim 1 wherein the catalytic composition has sufficient catalytic activity to provide a conversion of FCC feedstock of at least 30% at a CTO ratio of 10 and a contact temperature below 600° C.

7. The catalytic composition of claim 1 wherein the basic material is selected from the group consisting of compounds of alkali metals, compounds of alkaline earth metals, compounds of trivalent metals, compounds of transition metals, and mixtures thereof.

8. The catalytic composition of claim 1 wherein the basic material is supported on a carrier material.

9. The catalytic composition of claim 7, wherein the basic material is the oxide, the hydroxide or the phosphate of a transition metal, an alkali metal, an earth alkaline metal, or a transition metal, or a mixture thereof.

10. The catalytic composition of claim 9 wherein the basic material comprises an alkali metal compound.

11. The catalytic composition of claim 9 wherein the basic material comprises an alkaline earth metal compound.

12. The catalytic composition of claim 9 wherein the basic material comprises a compound of a transition metal.

13. The catalytic composition of claim 12 wherein the transition metal compound is selected from the group consisting of ZrO₂, Y₂O₃, Nb₂O₅, and mixtures thereof.

14. The catalytic composition of claim 1 wherein the basic material is a mixed metal oxide.

15. The catalytic composition of claim 14 wherein the basic material is a hydrotalcite.

16. The catalytic composition claim 1 wherein the basic material is an aluminum phosphate.

17. The catalytic composition of claim 1 wherein the basic material is doped with a metal cation.

18. The catalytic composition of claim 17 wherein the dopant metal cation is selected from metals of Group IIb, Group IIIb, Group IVb, the rare earth metals, and mixtures thereof.

19. The catalytic composition of claim 18 wherein the dopant metal is selected from the group consisting of La, Zn, Zr, and mixtures thereof.

20. The catalytic composition of claim 8 wherein the carrier is a refractory oxide.

21. The catalytic composition of claim 20 wherein the carrier is selected from alumina, silica, silica-alumina, titania, and mixtures thereof.

22. The catalytic composition of claim 1 further comprising a material having acidic sites.

23. The catalytic composition of claim 22 wherein the material having acidic sites is selected from the group consisting of silica sol, metal doped silica sol, and nano-scale composites of silica with other refractory oxides.

24. The catalytic composition of claim 1 wherein the at least one intermediate or small pore zeolite is selected from the ZSM family of zeolites.

25. The catalytic composition of claim 24 wherein the ZSM family zeolite is ZSM-5.

26. An FCC process comprising the step of contacting an FCC feedstock with the catalytic composition of claim 1 under FCC reaction conditions.

27. The process of claim 26 wherein the FCC feedstock is selected from the group consisting of vacuum gas oil, hydrotreated vacuum gas oil, atmospheric resid feed, and mixtures thereof.

28. The process of claim 27 which is carried out at a contact temperature in the range of about 400 to about 600° C.
